(19) United States
(12) Patent Application Publication
(10) Pub. No.: US 2025/0144883 A1
(43) Pub. Date: May 8, 2025

(54) SUSTAINABLE PRINTING THROUGH SELECTIVE RE-USE OPPORTUNITIES

(71) Applicant: INTERNATIONAL BUSINESS MACHINES CORPORATION, ARMONK, NY (US)

(72) Inventors: SILVIA CRISTINA SANTA ANA VELASCO, Guadalajara (MX); Carolina Garcia Delgado, Zapopan (MX); Perla Guadalupe Reyes Ramirez, Zapopan (MX); Paul Llamas Virgen, Guadalajara (MX); Jeremy R. Fox, Georgetown, TX (US)

(21) Appl. No.: 18/501,082

(22) Filed: Nov. 3, 2023

(51) Int. Cl. B29C 64/386; B33Y 50/00

(52) U.S. Cl. CPC B29C 64/386; B33Y 50/00

(57) ABSTRACT

A method, computer system, and a computer program product are provided for multi-dimensional printing. A printing request for printing tan object with at least one component is received. Information is obtained about the specifics of the object from a knowledgebase corpus database including at least a material requirement for printing of the object. The number of associated components and material and geometric requirements of each component and the object is analyzed. An output model is generated using at least one machine learning optimization model. The output model is generated based on the information obtained about the object and the analysis of the object's geometry and material requirements. The output model is stored in the knowledgebase corpus database.

### BACKGROUND

The present invention relates generally to the field of printing and more particularly to techniques for providing multi-dimensional printing using selective reuse opportunities.

Three-dimensional (3D) printing may be defined as the process of constructing a three-dimensional object from a particular modeling tool or through digital 3D models. This may be achieved in a variety of manners and through different processes. In one process, selective materials may be deposited and solidified under some form of a computer or digital control. Different materials may also be fused together or provided layer by layer. This process enables the output to be created through a mixture of different materials such as plastics, powder grains or liquids.

Four-dimensional (4D) printing technology may be thought of as an advancement of the 3D technology. This 4D printing technology may be used to create 3D shapes that can change in form when triggered by environmental stimulus. In some embodiment, 4D printing may use commercial 3D printers and smart material to achieve the final output or result. Smart materials may have thermomechanical properties that respond to light and temperatures, environmental stimuli and other external factors. This type of 4D printing may add the dimensions of time to the 3D printing as objects may modify their shapes autonomously and without further human intervention.

### SUMMARY

Embodiments of the present invention disclose a method, computer system, and a computer program product for multi-dimensional printing. A printing request for printing tan object with at least one component is received. Information is obtained about the specifics of the object from a knowledgebase corpus database including at least a material requirement for printing of the object. The number of associated components and material and geometric requirements of each component and the object is analyzed. An output model is generated using at least one machine learning optimization model. The output model is generated based on the information obtained about the object and the analysis of the object's geometry and material requirements. The output model is stored in the knowledgebase corpus database.

### BRIEF DESCRIPTION OF THE SEVERAL VIEWS OF THE DRAWINGS

These and other objects, features and advantages of the present invention will become apparent from the following detailed description of illustrative embodiments thereof, which may be to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment, according to at least one embodiment;

FIG. 2 provides an operational flowchart for printing a multidimensional object, according to one embodiment;

FIG. 3 provides a block diagram of a digital printer capable of printing a multidimensional object such as that provided in FIG. 2, according to one embodiment;

FIG. 4 provides a block diagram of a next processing stage of the embodiment of FIG. 3 in the printing of the multidimensional object, according to one embodiment; and

FIG. 5 provides a block diagram of a final processing stage of the embodiment of FIG. 4 in the printing of the multidimensional object, according to one embodiment.

### DETAILED DESCRIPTION

Detailed embodiments of the claimed structures and methods may be disclosed herein; however, it can be understood that the disclosed embodiments may be merely illustrative of the claimed structures and methods that may be embodied in various forms. This invention may, however, be embodied in many different forms and should not be construed as limited to the exemplary embodiments set forth herein. Rather, these exemplary embodiments may be provided so that this disclosure will be thorough and complete and will fully convey the scope of this invention to those skilled in the art. In the description, details of well-known features and techniques may be omitted to avoid unnecessarily obscuring the presented embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

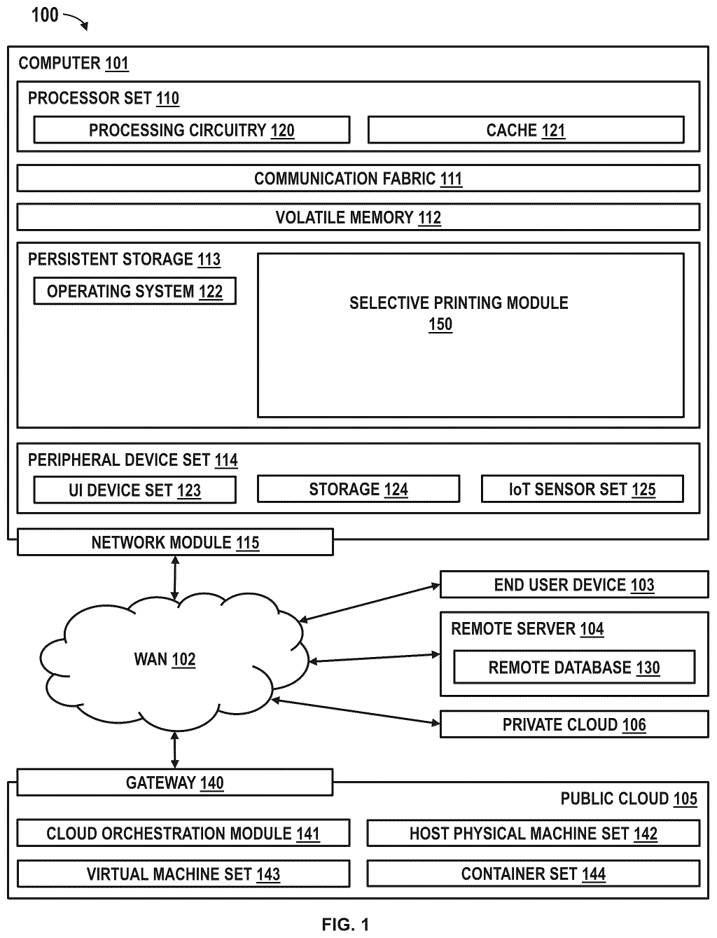

FIG. 1 provides a block diagram of a computing environment 100. The computing environment 100 contains an example of an environment for the execution of at least some of the computer code involved in performing the inventive methods, such as code change differentiator which is capable of providing a selective printing module (150). In addition to this block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 of FIG. 1 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open-source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers.

A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Three-dimensional (3D) printing may be defined as the process of the construction of a three-dimensional object from a particular modeling tool or through digital 3D models. The final printed output may be comprised of materials that are deposited, fused and/or solidified under some form of a computer or digital control. Four-dimensional (4D) printing builds on 3D printing by creating 3D shapes that can change in form when triggered by environmental stimulus. In this way, 4D printing may add the dimensions of time to the 3D printing, as the objects may modify their shaper autonomously and without further human intervention

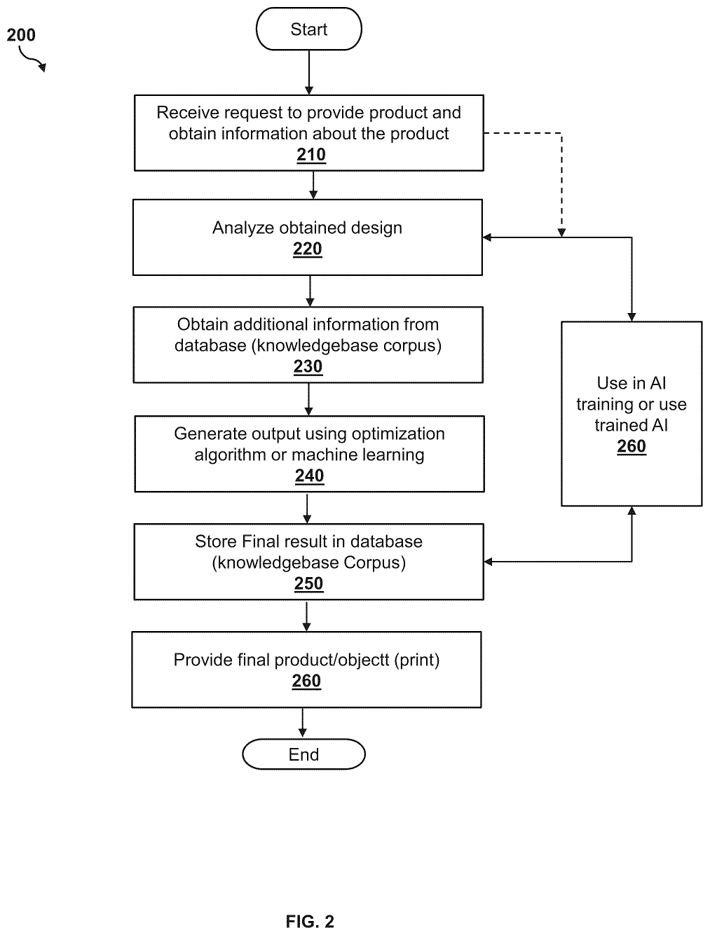

One challenge associated with the multi-dimensional printing (3D/4D process) is associated cost and waste disposal. Current processes do not efficiently reuse materials due to a number of quality issues such as those associated with the used/spent filaments. Material waste is both costly and disposal of waste may be potentially harmful to the environment. FIG. 2 is a flowchart of a process providing an optimization methodology that addresses these challenges.

In Step 210, a printing request for printing an object is received. The object may be comprised of a plurality of components that each require different material and geometric specifics. The request may accompany special requirements for a model to be designed or the information may be obtained. The information may be provided by one or more users, through one or more devices or be automated through the use of one or more AI engines. Information received (or obtained from the corpus as discussed later) may include material use requirements, sustainability needs, and different requirements associated with one or more components that comprise the entire object to be printed.

In Step 220, the product to be designed and produced may be analyzed. The analysis may be with respect to its plurality of the pieces, such as those that may be printed using 3D/4D printed designs. one embodiment. For example, the number of pieces or components that need to be designed for the object to be printed and associated required materials for each piece or component is considered.

One consideration that goes into the analysis is also the selection of materials needed. Information may also be provided in regard to the availability of resources available to acquire the materials. This analysis may include design of 3D/4D printed pieces and the geometry of one or more pieces or the overall object or product. The physical properties of the piece(s) will also be considered as well as material properties needed for constructing the piece or the overall result.

In Step 230, a database may be available to provide more information about the product or each individual piece. It should be noted that Steps 220 and 230 can be performed in reverse order or simultaneously. The database may include comments from a variety of sources such as other designers, engineers or manufacturers to ensure that the pieces are designed with potential reuse opportunities in mind as a collective consensus. The database may also include prior history such as examples of previously similar projects or similarly designed individual pieces. In one embodiment, information about different materials or material requirements may exist for design and use purposes.

In Step 240, an output or an output model may be generated by providing the information previously obtained and analyzed to one or more machine learning models. In one embodiment, machine learning algorithms can be used to predict the potential reuse opportunities for a given 3D/4D printed piece. This could involve training a model on a dataset of previously 3D/4D printed pieces and their reuse opportunities, and then using that model to make predictions for new pieces.

In one embodiment, one or more algorithms are used to incorporate information gathered in Steps 210-230 to provide an optimized output. In addition, one or more algorithms are used to optimize potential use or reuse of materials needed or can be acquired from other sources to complete the project and the final object printing. The output will have optimized all opportunities for 3D/4D construction through, for example printing. It will reuse components for existing products and will be more efficient and more sustainable. In one embodiment, the model will consider both individual pieces/components and the entire object for the printed project as a whole. In one embodiment, the physical properties, the design and geometry of each piece is analyzed to determine if it can be used in other printed applications or components (especially in 3D/4D applications). Additionally, the analysis may also involve looking at the material properties of the piece, such as its strength and durability, to determine if it could withstand the demands of other uses.

In Step 250, the information relating to the generated output (result) will then be stored in a knowledge base corpus alongside all specifics of the geometry and material considerations and analysis. The corpus will be used for use and for ongoing AI training. In one embodiment, the database is that of sustainable 3D/4D printed pieces, containing information about their design, material properties, and potential reuse opportunities.

In one embodiment, the database (corpus) used in Steps 220 and 250 provides information about component design, material properties, and potential reuse opportunities. This database could be searched and analyzed to identify pieces that could be used for other purposes, such as creating new 3D/4D printed objects, or as components in existing products.

In addition, the knowledgebase corpus (database) is important in allowing for the collaboration between designers, engineers, and manufacturers of such products. The information in the corpus may have already existed before Step 220. This is important in getting the best solutions for optimization and reusing of the 3D/4D printed pieces. This would also help involve all key players from the start in the design process, prototyping and decision stages to ensure that the pieces are designed with potential reuse opportunities in mind as a collective consensus. In this way, the process 200 also allows for the creation of a more sustainable and resource-efficient approach to 3D/4D printing by promoting the reuse of 3D/4D printed pieces. By finding new ways to use these pieces, it could help reduce waste and minimize the environmental impact of 3D/4D printing.

The AI training step is provided in Step 260. The training is an ongoing procedure during the entire process 200 but that will also more specifically uses the knowledgebase corpus.

In one embodiment, as illustrated in Step 270, a final product as in the object requested to be printed is then produced using the model previously generated. This may also include the recommended materials or at some point the recommendations may be overridden by the user.

The process 200 will provide to a more efficient and sustainable approach to 3D/4D printing by promoting the reuse of 3D/4D printed pieces that involves the use of a cutting blade for slicing, dicing, and ameliorating various shapes from standard sizes into reusable small blocks. In addition, process 200 addresses the problem of waste in 3D/4D printing, by optimizing the reuse of printed pieces. Within 3D/4D Printing today, there is a significant amount of waste material generated during the printing process that cannot be reused due to quality issues with the used/spent filament. This can result in a significant amount of unnecessary material waste, which is both costly and potentially harmful to the environment.

Process 200 creates a more sustainable and resource-efficient (environmentally friendly) approach to 3D/4D printing by promoting the reuse of 3D/4D printed pieces. By finding new ways to use these pieces, it could help reduce waste and minimize the environmental impact of 3D/4D printing. This could involve the use of optimization algorithms and data analysis to identify potential reuse opportunities for 3D/4D printed pieces, as well as the creation of a database of 3D/4D printed pieces and their potential reuse opportunities. This database (knowledge corpus) could be searched and analyzed to identify pieces that could be used for other purposes, such as creating new 3D/4D printed objects, or as components in existing products.

The technology involving 3D/4D printing may have many impacts in a variety of fields ranging from automotive and aerospace to medical technologies. Optimizing production and optimization helps with additive manufacturing as well. In this way, components can develop more efficiently and with more flexibility. This will help provide new functions and help meet existing requirements. Controlling ranges from compact designs through angled geometries inside the component to the smallest functional structures, will impact the end result of the product. In addition, spare parts can be e manufactured to meet individual requirements that would have otherwise been difficult to obtain or have long delivery periods. The economical production of individual parts and small quantities is possible. This has been an enormous challenge with other manufacturing processes so far.

To ease understanding two examples can be used with the understanding that many other scenarios can be present in alternate situations and using various embodiments. In the first example, J is a designer who is working on a 3D printing project at his house. J is having difficulty finding the right pieces to use in J's designs, so J decides to use the techniques provided by process 200 to find the pieces needed. J searches the database (the knowledge corpus) for 3D printed pieces and finds several pieces that match the criteria. J can analyze the design, material properties, and potential reuse opportunities of each piece and determine if it could be used in his project. J is then able to collaborate with other designers, engineers, and manufacturers to get their input on the best ways to use the pieces. The process 200 will allow for the 3D pieces to be cut through the process we define, which allows for new pieces to be generated for reuse. Through this, J can find the pieces needed to complete the project without wasting any previously used material or spent filament.

In a second scenario for example, C is a Lead Engineer for an automotive industry manufacturer who is looking for ways to reduce the amount of waste in her manufacturing process. C decides to use process 200 to find a way to reuse 3D/4D printed pieces. C searches the database (the defined knowledge corpus) and finds several pieces that could be used in her manufacturing process (fitting the collective set of requirements). C is then able to analyze the design, material properties, and potential reuse opportunities of each piece and determine if it could be used in C's manufacturing process for the automotive parts. C is then able to collaborate with other designers, engineers, and manufacturers within her business to get their input on the best ways to use the pieces. During the process where the pieces are sliced and cut into reusable new pieces, then C can find ways to reuse 3D/4D printed pieces to reduce the manufacturing waste without compromising C's production quality standards for the parts. This allows C to find ways to reuse 3D/4D printed pieces to reduce their waste while still maintaining the high standards of accuracy and precision that are required in the automotive industry.

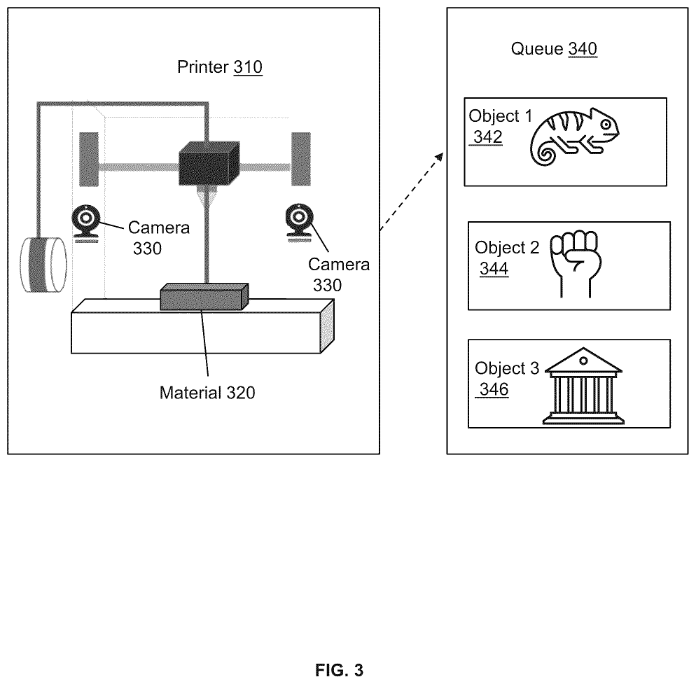

FIGS. 3-5 illustrate block diagrams for a next step process progression of an example provided as per embodiment of FIG. 2. In FIG. 3 a contextual illustration is provided by the block diagram. Several designs of different objects have been provided as can be seen by reference numerals 342, 344 and 346 that will be printed in a queue (340). The objects to be printed are in 3D/4D configuration and will be printed in layers. Cameras 330 and 332 are present to check the printing process and monitor if there is a quality problem or an issue during the printing. There is a layer printer 310 that will print the layer out of material 320. In one embodiment, if there are any problems in the process with any of the layers, the printer will stop the printing process. In one embodiment, if the printing issues arise due to printing of the layers of one object in the queue-here object 342—the printing process when feasible may move on to printing layers of the next object in the queue (here object 344).

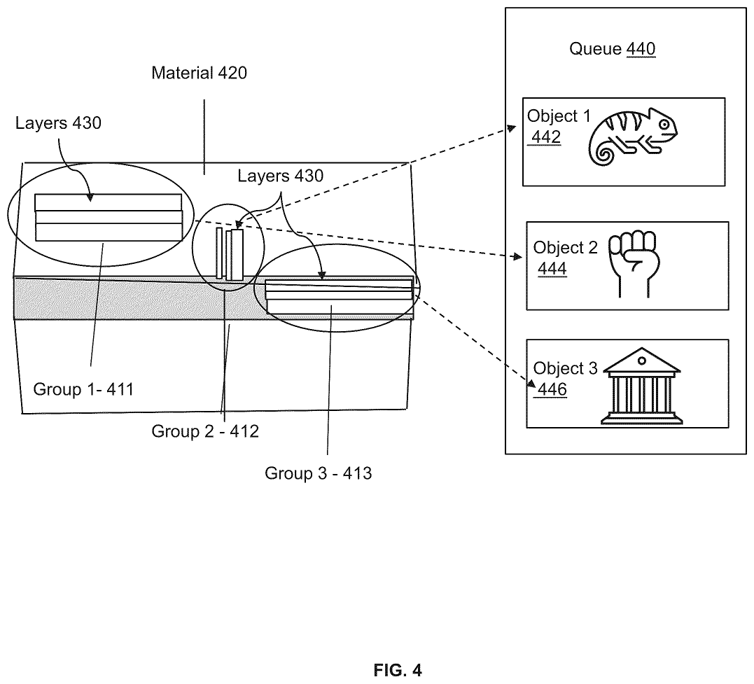

In FIG. 4, the material 320 of FIG. 3 is shown in more detail and denoted in FIG. 4 as 420. Even though the material is shown to be as a solid unit for ease of viewing, in different embodiments, the material can be made from more than one substance in different areas and therefore each area may be denoted for printing of different parts of an object to be printed, or different objects. Material 420 will be analyzed so as to select areas and dimensions of layers that can be obtained to print different objects in the queue or different parts of the objects in the queue. Once compared system will select the possible object can be printed with current layers printed wo quality problems.

The layers are divided in groups 1-3 as denoted by 411-413. The layers will be divided in groups depending on the position and type of material that has to be used for different objects 442-446. Each group 411-413 will have different dimensions including different lengths, widths and depths that may be different than other groups and the number of layers and the dimensions will depend on the object 442-446 that is to be printed from queue 440. The groups 411-413 will be compared with the dimensions of the printing queue objects on the list and verified if some groups (layers) can be reutilized in other objects so as not to waste materials and be efficient.

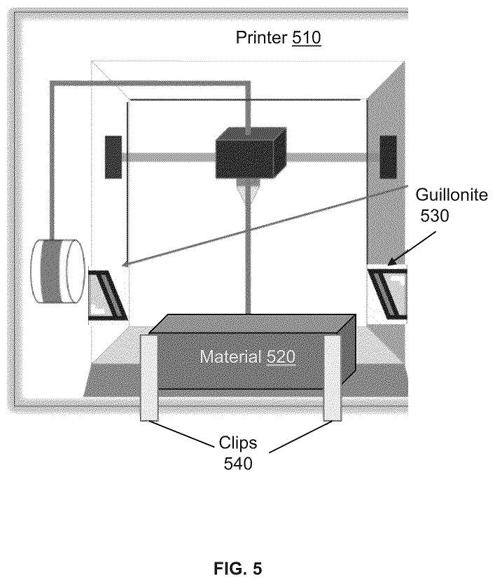

FIG. 5 is a block diagram illustration of printer 510 in a next stage processing step as to that of FIG. 4. As can be seen, clips 540 are used to keep material 520 in place without movement. Cutting component (guillotine) 530 are used and can be moved in horizontal and vertical channels for cutting etc. In one embodiment, a mechanism may be active and the clips 540 (located here at X axis but alternate embodiments can be arranged) will hold the object that was printing then the cutting component 530 will start cutting material that is not needed (groups-layer) and do building blocks. The cutting component can move in vertical and/or horizontal directions through the channels. The cutting component will move in horizontal or vertical directions to cut the pieces in the group needed, using the camera (not shown here) will validate if the building blocks have the length, width and depth needed. Once the system/mechanism splits the groups, the cutting component can hide (such as in the walls of the printer/printing environment) to avoid any unsafe situation. At this point, the selected building block of material for each section will be used to start printing the queue objects that were previously selected.

The descriptions of the various embodiments of the present invention have been presented for purposes of illustration but may be not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for multi-dimensional printing, comprising:
receiving a printing request for printing an object having an object geometry, wherein said object includes a plurality of components;
obtaining information relating to specifics of said object to be printed from a knowledgebase corpus database, wherein said information includes at least a material requirement for printing of said object;
analyzing said object and determining said object geometry and said at least material requirements for each of said plurality of components for said object;
generating an output model using at least one machine learning optimization model, wherein said output model is based on said information obtained about said object and said analysis of said object's geometry and material requirements; and
storing said output model in said knowledgebase corpus database.

2. The method of claim 1, wherein said knowledgebase corpus database is used to train at least one Artificial Intelligence (AI) engine.

3. The method of claim 1, further comprising printing said object using said generated output model output.

4. The method of claim 1, wherein said printing is three-dimensional (3D) printing.

5. The method of claim 1, wherein said printing is four-dimensional (4D) printing.

6. The method of claim 1, wherein said information about said object to be printed is also received at same time of receiving said printing request.

7. The method of claim 1, wherein said object comprises a machine learning optimization model optimizing for analyses of said material for each of said components of said object to determine material reusability.

8. The method of claim 7, wherein said machine learning optimization model also analyses each of said components for sustainability.

9. The method of claim 7, wherein said machine learning optimization model also analyses each of said components for environmental impacts associated with usability and waste management.

10. The method of claim 1, wherein said knowledgebase corpus includes input from at least one third party individual.

11. The method of claim 10, wherein said third party individuals include at least designers, engineers, and material source providers of said components of said object to be printed.

12. The method of claim 1, wherein said object's geometry includes a length, a width, a depth and any angles of connection.

13. A computer system for multi-dimensional printing, comprising:
one or more processors, one or more computer-readable memories and one or more computer-readable storage media;
program instructions, stored on at least one of the one or more storage media for execution by at least one of the one or more processors via at least one of the one or more memories, to receive a printing request for printing an object, wherein said object includes at least one component;
program instructions, stored on at least one of the one or more storage media for execution by at least one of the one or more processors via at least one of the one or more memories, to obtain information relating to specifics of object to be printed from a knowledgebase corpus database wherein said information includes at least a material requirement for printing of said object;
program instructions, stored on at least one of the one or more storage media for execution by at least one of the one or more processors via at least one of the one or more memories, to analyze said object's geometry and material requirements including that of each component;
program instructions, stored on at least one of the one or more storage media for execution by at least one of the one or more processors via at least one of the one or more memories, to generate an output model using at least one machine learning optimization model, wherein said output model is based on information obtained about said object and said analysis of said object's geometry and material requirements; and
program instructions, stored on at least one of the one or more storage media for execution by at least one of the one or more processors via at least one of the one or more memories, to store said output model in said knowledgebase corpus database.

14. The computer system of claim 13, wherein said knowledgebase corpus database is used to train at least one Artificial Intelligence (AI) engine.

15. The computer system of claim 13, wherein said printing is three-dimensional (3D) printing.

16. The computer system of claim 13, wherein said printing is four-dimensional (4D) printing.

17. The computer system of claim 13, wherein said knowledgebase corpus includes input from third party individuals.

18. The computer system of claim 17, wherein said third party individuals include at least designers, engineers, and material source providers of said components of said object to be printed.

19. The computer system of claim 13, wherein said analysis step includes determining dimensions of each component including length, width, depth and angles of connection.

20. A computer program product for providing cleansing steps for using a plurality of different transformation assets, the computer program product comprising:
one or more computer readable storage media;
program instructions, stored on at least one of the one or more storage media for execution by at least one of the one or more processors via at least one of the one or more memories, to receive a printing request for printing an object, wherein said object includes at least one component;
program instructions, stored on at least one of the one or more storage media for execution by at least one of the one or more processors via at least one of the one or more memories, to obtain information relating to specifics of object to be printed from a knowledgebase corpus database wherein said information includes at least a material requirement for printing of said object;
program instructions, stored on at least one of the one or more storage media for execution by at least one of the one or more processors via at least one of the one or more memories, to analyze said object's geometry and material requirements including that of each component;
program instructions, stored on at least one of the one or more storage media for execution by at least one of the one or more processors via at least one of the one or more memories, to generate an output model using at least one machine learning optimization model, wherein said output model is based on information obtained about said object and said analysis of said object's geometry and material requirements; and
program instructions, stored on at least one of the one or more storage media for execution by at least one of the one or more processors via at least one of the one or more memories, to store said output model in said knowledgebase corpus database.
